(19) United States
(12) Patent Application Publication
(10) Pub. No.: US 2014/0141179 A1
(43) Pub. Date: May 22, 2014

(54) METHOD FOR PRODUCING IMPROVED FEATHERS AND IMPROVED FEATHERS THERETO

(71) Applicants: Christopher M. Pavlos, Austin, TX (US); Robert P. Harkabus, Austin, TX (US); Keris Ward, Austin, TX (US); Donald E. Owens, Evansville, IN (US); Randy Harward, Ojai, CA (US); Tetsuya O'Hara, Ojai, CA (US); Duncan Ferguson, Norwood, CO (US)

(72) Inventors: Christopher M. Pavlos, Austin, TX (US); Robert P. Harkabus, Austin, TX (US); Keris Ward, Austin, TX (US); Donald E. Owens, Evansville, IN (US); Randy Harward, Ojai, CA (US); Tetsuya O'Hara, Ojai, CA (US); Duncan Ferguson, Norwood, CO (US)

(21) Appl. No.: 13/697,284

(22) PCT Filed: May 12, 2011
(86) PCT No.: PCT/US11/36332

§ 371 Date: Nov. 18, 2013

Related U.S. Application Data
(60) Provisional application No. 61/334,082, filed on May 12, 2010.

(51) Int. Cl. D06M 19/00; B68G 1/00

(52) U.S. Cl. CPC D06M 19/00; B68G 1/00
USPC 428/16; 427/569; 428/34.1

(57) ABSTRACT

The invention relates to a method of producing improved feathers (including down feathers) by coating said feathers with coating materials via plasma deposition resulting in coated feathers and down feathers with improved properties such as moisture resistance, hydrophobicity, fill power (loft), and other improved characteristics.

### PRIORITY CLAIM

This application claims the benefit of the filing date of U.S. Provisional Patent Application No. 61/334,082 filed on May 12, 2010, which is herein incorporated by reference in its entirety.

### TECHNICAL FIELD OF THE INVENTION

The invention relates generally to treated feathers (including down feathers) for use as filling products, and in more specifically to treated feathers produced by plasma deposition of coating materials resulting in improved moisture resistance, hydrophobicity, fill power (loft), and other improved characteristics.

### BACKGROUND OF THE INVENTION

Natural products such as feathers, including down, have been used in clothing, bedding, and pillows for thousands of years. Down taken from geese and other birds is often preferred for this purpose due to its advantages in trapping air and heat in small pockets within the article, creating insulation and cushioning. Likewise, as a natural product, down is often considered to be a higher-end filling in the bedding and clothing industries, as there is a traditional precedence of high-quality feather down being used by upper-class figures in society throughout history, beginning with the earliest known history of usage down feather beddings and pillows have been found within the tombs of ancient Egyptian pharaohs.

However, some aspects of down give it disadvantages over modern, man-made materials. For instance, down becomes saturated with moisture present in the environment, including air-borne moisture. Down absorbs water hygroscopically, which causes it to clump and lose loft. This process is significantly accelerated in rainy environments. For this reason, many consumers who would prefer natural down fills often use synthetic fills, particularly for outdoor applications in which exposure to moisture is a common occurrence. Although when dry, down is ideal in almost all ways for use in outdoor coats, jackets, and sleeping bags due to its excellent insulating properties, its susceptibility to moisture and slow drying time often prevent its use in these fields.

As mentioned above, down offers excellent thermal properties, and has good lofting characteristics. This means that the down traps small pockets of air efficiently. The small pockets of air provide the thermal barrier. Down has the added property that it can be packed into a very small space. For outdoor equipment, down is considered to be the single best insulating material available due to its light weight, compressibility, and heat retention. However, synthetic insulations work better than down when wet and are easier to dry, whereas down insulation does not work at all when wet and takes a very long time to dry out. Thus people who expect a significant amount of rain when camping will either bring a down sleeping bag with a water-resistant shell, or a bag with synthetic fill.

The presence of moisture is known to have a negative impact on the properties of down feathers found most desirable in bedding and filling in clothing it is soft, possesses great loft, and is a natural insulator. When wet, these properties are negatively affected. Moisture's impact on loft, the guiding measurement by which the quality of down is measured, is severe. Moisture causes fibers within the down to clump together, preventing the air pockets from forming within the down which create both insulation and “softness.” Once wet, down takes a very long time to dry, up to days depending on the conditions. In nature, larger, vaned feathers keep down feathers from being negatively affected by moisture.

Despite its superb insulating properties down is, after all, an insulator in the natural world—down has traditionally not been considered a desirable fill for outdoor materials such as coats and sleeping bags in all situations. In situations where the loss of loft or insulating ability in the down could render the down-containing product uncomfortable or even life threatening, down has been avoided. When traditional, uncoated down becomes wet, it loses its insulating properties—unlike wool or other comparable synthetic materials which retain some insulating properties even when damp. Likewise, because down is susceptible to moisture, it becomes very difficult to dry. Drying time for down is long because of the same properties which allow it to trap air, also work to trap moisture.

Furthermore, feather pillows are often judged by the amount of cushion or resistance they supply. This rating is created by “loft,” the ability for feathers to expand from a compressed state and trap large amounts of air. Loft is inhibited by moisture in the air, which causes feathers to clump together, reducing their ability to expand around the consumer's body as pressure is put on the pillow, creating less resistance, and thus less cushioning, for the user.

The “fill power” of down and feathers refers to the loft or density it is defined as the volume of space that one ounce of down insulation will fill upon application of a specified amount of compressive force. Fill power is important in insulation and bedding because the greater the fill power, the less materials necessary to create the same amount of loft. Likewise, greater fill power will result in a firmer pillow or bedding.

While purely synthetic materials do offer some advantages regarding moisture resistance over their natural counterparts, there are disadvantages here as well. Synthetic insulation materials are generally higher in weight, have less compressibility, and are less comfortable than down. Additionally, many are highly flammable, such as polyurethane foams. Others give off an unnatural odor which is unpleasant to the consumer. Above all, there is a general suspicion among consumers toward man-made products of which the lasting effects on health after a lifetime of use are unknown.

Many methods of imparting water repellency to textile materials are known. These usually involve the use of hazardous or noxious chemicals, liquor baths, or spray-type methods, resulting in time-consuming and expensive processes with only moderate results (See U.S. Pat. No. 4,537,594). The introduction of silicone and fluorocarbon based coatings has further improved hydrophobicity, and other improved characteristics.

While techniques to impart hydrophobicity known in the art work very well for some textiles, down cannot be effectively processed by these methods due to its extremely delicate nature. Heavy applications of water repellant applied by spray or immersion can cause the down to gain weight and lose loft.

The prior art teaches treating feathers predominately through solvent-based approaches or bathing techniques, which require extensive treating and drying times with multiple steps, and which result in products which are non-uniform, and lower performing. In addition, the use of solvents and other wet chemistries cause loss of essential and natural oils present on the feathers which are important for retained integrity over time. There is at present no identifiable commercial presence for products treated by the prior art methods.

Therefore, there exists a need in the art for novel treatment methods for producing high performance feathers for use as filling in bedding, clothing and other insulative applications with a single-step, controllable process.

### SUMMARY OF THE INVENTION

The presently claimed and disclosed invention provides an innovative and novel process for utilizing plasma deposition technology for deposition of coating materials which are unique sources for providing permanent hydrophobicity, general water repellency, improved drying time, improved integrity and slidability, and improved fill power. The improved results are achieved rapidly and effectively through covalent and permanent attachment of compounds to the materials with greatly improved performance and characteristics.

The present method defines a means by which feathers (including down feathers) can be made hydrophobic, have permanently enhanced loft and additional numerous advantages over untreated feathers. This is achieved by processing feathers through gas phase pulsed plasma polymerization, resulting in the application of a very thin functionalized coating to the surface of the feather. This coating acts as a permanent barrier against moisture, enhancing drying time and insulating properties in wet conditions, as well as increasing loft and fill power. By taking an organic, recognizable filling such as down feathers and utilizing plasma gas phase deposition technology to permanently coat the feathers, the resulting hybrid material offers the advantages of both organic and synthetic materials.

Feathers processed with a gas phase pulsed plasma polymerization process become resistant to moisture and thus retain insulation and loft in wet conditions. Plasma processing coats feathers with a thin film which prevents the absorption of moisture, thus imbuing the products with an improved drying time.

An independent testing facility showed that plasma treatment of down feathers resulted in a significant increase, greater than ten percent (10%), in fill power over the untreated reference material. Both pulsed and continuous wave plasma treatments may be employed in coating the down.

The supple coating supplied by the method described in this invention provides the feathers with hydrophobicity, resulting in a product which is not affected by ambient moisture or rain and ultimately has a greater loft than down feathers can provide in a natural state. Because of this, the hybrid material is actually superior to its unprocessed counterpart.

The present invention is particularly beneficial because of the single-step processing of the feathers using plasma deposition technology, wherein a monomer, or compound material, may be introduced into a chamber under controlled temperatures and pressure, and with additional controlled power and duty cycle settings, the compound material is activated using a plasma discharge, thus forming a thin, permanent layer of the compound materials on the feathers present in the deposition chamber. It has been previously shown that a plasma polymerization process may be used with perfluorocarbon compounds to create polymers and polymers films. (See U.S. Pat. No. 5,876,753; U.S. Pat. No. 6,306,506; U.S. Pat. No. 6,214,423; all of which are herein incorporated by reference).

### BRIEF DESCRIPTION OF THE DRAWINGS

Preferred and alternative examples of the present invention are described in detail below with reference to the following drawings:

FIG. 1 depicts an FTIR spectrum of a plasma deposited thin film using HMDSO as the monomer. The film was deposited on a silicon wafer for FTIR analysis.

FIG. 2 depicts an FTIR Spectrum of a plasma deposited thin film using C6F14 as the monomer. The film was deposited on a silicon wafer for FTIR analysis.

FIG. 3 depicts an FTIR Spectrum of a plasma deposited thin film using C9F18 as the monomer. The film was deposited on a silicon wafer for FTIR analysis.

FIG. 4 depicts a Fisher Scientific Vortex Mixer.

FIG. 5 depicts untreated down feathers after vortexing for (left to right): 0, 15, 30, 45, 60, 75, and 90 seconds. The feathers begin to wet after 15 seconds (parts of the feathers are below the surface of the water).

FIG. 6 depicts Plasma treated down feathers after vortexing for (left to right): 0, 15, 30, 45, 60, 75, and 90 seconds. A siloxane coating was deposited on this group of feathers using HMDSO as the monomer.

FIG. 7 depicts a line graph showing comparative performance in the vortex test of pulsed plasma-treated feathers using either HMDSO, C6F14, or C9F18 as the monomer. Untreated feathers are also shown for reference.

FIG. 8 illustrates a bar chart showing comparative fill powers associated with three treated versus one untreated sample in accordance with the International Down and Feather Bureau (IDFB) testing regulations Part 10-B version June 2008.

### DETAILED DESCRIPTION OF THE PREFERRED EMBODIMENT

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “feathers” as used herein refers to the epidermal growths that form the distinctive outer covering, or plumage, on birds. They are considered the most complex integumentary structures found in vertebrates. There are two basic types of feathers: vaned feathers which cover the exterior of the body, and down feathers which are underneath the vaned feathers. The pennaceous feathers are a type of vaned feather. Also called contour feathers, pennaceous feathers arise from tracts and cover the whole body. A typical vaned feather features a main shaft, called the rachis. Fused to the rachis are a series of branches, or barbs; the barbs themselves are also branched and form the barbules. These barbules have minute hooks called barbicels for cross-attachment. Down feathers have short or vestigial rachis, few barbs, and barbules that lack barbicels, so the barbules float free of each other, allowing the down to trap much air and provide excellent thermal insulation, thus its usefulness as filling in products.

Down feathers are both soft and excellent at trapping heat; thus, they are sometimes used in high-class bedding, especially pillows, blankets, and mattresses. They are also used as filling for winter clothing, such as quilted coats, as well as for and sleeping bags. Goose and eider down in particular have great loft, the ability to expand from a compressed, stored state to trap large amounts of compartmentalized, insulating air. Although even compartmentalized air can still conduct heat through convection, down allows less convection better than synthetics because a comparatively large amount of the air trapped by down is statically attached to the feathers. Because the feather fibers are small, abundant and overlapping, the air cannot move or create convection to the degree that is allowed by synthetics. As a result, down is an exceptionally efficient insulator.

Coating Compounds may include perfluorocarbon compounds or siloxane compounds. Perfluorocarbon compounds, such as perfluorohexane, yield plasma polymerized fluorinated films that exhibit good adhesion to many organic and inorganic substrates, have low intermolecular forces, low friction coefficient, hydrophobic behavior, and are biocompatible. Polymers of hexafluoro-propylene oxide (C₃F₆O), butyltetrahydrofuran (PF₂BTHF, C₈F₁₆O), perfluorohexane (C₆F₁₄), hexafluoropropene trimer (C₉F₁₈), and perfluoropropylene (C₃F₆) create excellent coatings or films that are capable of attaching to the feathers. Siloxane compounds, such as hexamethyldisiloxane (HMDSO), also yield plasma polymerized films that exhibit good adhesion to the feathers, as shown in the examples herein, have low intermolecular forces, low friction coefficient, hydrophobic behavior, and are biocompatible.

Plasma Enhanced Chemical Vapor Deposition (PECVD), or plasma deposition, provides for a solventless, single-step coating process in which the coating material may be modified depending on the process, itself. For example, the process is able to control coatings, and hence, surface interaction with an environment, by adjusting the side groups, thickness, wettability, molecular weight, cross-linking density, surface area and/or composition of the coating material.

Plasma deposition is a mechanism where a plasma discharge is used to activate the surfaces of the feathers. This activation permits covalent grafting of a carbonaceous material to the surface of the feathers, as assisted by the high energy impacts created by the positively charged radical species, produced by the plasma discharge, impacting with the negatively charged particle substrates.

A plasma is any gas in which a significant percentage of the atoms or molecules are ionized. Fractional ionization in plasmas used for deposition and related materials processing varies from about 10⁻⁴ in typical capacitive discharges to as high as 5-10% in high density inductive plasmas. Processing plasmas are typically operated at pressures of a few millitorr to a few ton, although arc discharges and inductive plasmas can be ignited at atmospheric pressure. Plasmas with low fractional ionization are of great interest for materials processing because electrons are so light, compared to atoms and molecules, that energy exchange between the electrons and neutral gas is very inefficient. Therefore, the electrons can be maintained at very high equivalent temperatures—tens of thousands of kelvins, equivalent to several electronvolts average energy—while the neutral atoms remain at the ambient temperature. These energetic electrons can induce many processes that would otherwise be very improbable at low temperatures, such as dissociation of precursor molecules and the creation of large quantities of free radicals.

A second benefit of deposition within a discharge arises from the fact that electrons are more mobile than ions. As a consequence, the plasma is normally more positive than any object it is in contact with, as otherwise a large flux of electrons would flow from the plasma to the object. The voltage between the plasma and the objects in its contacts is normally dropped across a thin sheath region. Ionized atoms or molecules that diffuse to the edge of the sheath region feel an electrostatic force and are accelerated towards the neighboring surface. Thus, all surfaces exposed to the plasma receive energetic ion bombardment.

With the present invention, both pulsed and the more conventional continuous-wave (CW) plasma deposition approaches may be used. Using a pulsed plasma approach provides excellent film chemistry control during polymer formation and control of film thickness. Pulsed applications may reduce or eliminate undesirable plasma-induced chemical changes to articles. In addition, under pulsed reaction conditions, significant film formation occurs during plasma off periods (and undesirable high energy reactions between ion-radical and the article are minimized). Since the deposition of the film is carried out via a gas phase process, all areas exposed to the gases are coated equally, thus providing a conformal coating. These studies demonstrate that the conformal application is applicable to objects of all types of shapes and sizes, including feathers and fibers. The conformal nature of these films provides complete surface coverage of the feathers in a highly efficient manner.

The average power employed under pulsed plasma conditions was calculated according to the formula shown below (1), where τₒₙ and τ_{off} are the plasma on and off times and Pₚₑₐₖ is the peak power. By using pulsed plasma polymerization, the average power employed during film formation was often much lower than the power employed under continuous wave reaction conditions, because of the relatively longer plasma off times compared to plasma on times.

P_{average}=(τₒₙ/(τₒₙ+τ_{off}))×Pₚₑₐₖ (1)

Deposition (polymerization) of the coating or polymer film of the present invention was controlled by altering a number of variables associated with the plasma reactor. Variables included duty cycle, power input, peak power, flow rate of the monomer, pressure of the reactor, coating time period, and quantity of down feathers introduced into the reaction chamber at a time. While many of these variables are optimized for the particular size and orientation of the plasma reactor, such as power input, peak power, flow rate of the monomer, and quantity of feathers, those skilled in the art will appreciate that suitable plasma on/off times (duty cycles) were generally in the millisecond range, although continuous is also suitable. Suitable coating periods were typically between about 20 seconds and 2 hours. The pressure of the reactor typically varied from atmospheric to 5 millitorr. Temperatures may also be varied in the process to affect reaction rates and monomer volatility.

Feathers may be loaded at varying density into the reaction chamber. Improved attributes of treated feathers have been found at loading densities varying from 0.041 grams/cubic to 0.01 grams/cubic inch. In a further embodiment, feathers may be continuously added and/or withdrawn into or out of a plasma reaction zone, thereby facilitating non-batch, fed-batch, and/or continuous processing of down, with agitation provided mechanically, pneumatically, by gas flow, or by gravity.

With the present invention, in the context of pulsed plasma embodiments, suitable plasma on/off times (duty cycles) were generally in the millisecond range. As used herein, duty cycles are reported as on/off times per cycle and provided in units of ms/ms.

### EXAMPLES

### Example 1

In this example, feathers (down) were treated. Down feathers (7.5 g) are preloaded into a plastic mesh tube and placed in a 100° F. oven overnight prior to plasma processing in order to remove adsorbed water. The tube is then loaded into a plasma chamber and vacuum is drawn down to a base pressure of 0-3 mTorr. Perfluorohexane (C₆F₁₄) is introduced into the chamber at a flow rate of 100 sccm. A throttle valve wired to a pressure controller and transducer is utilized to achieve a constant pressure between 1-1500 mTorr. Radio frequency (RF) energy at 13.56 MHz is discharged between two parallel plate electrodes residing on opposite sides of the plasma chamber. The plasma is ignited continuously for a period of 120 minutes. During processing, the plastic mesh tube is rotated to ensure uniform coating. After processing, the feathers are removed from the chamber and conditioned overnight at 70-75° F. and 60-65% relative humidity prior to vortex testing.

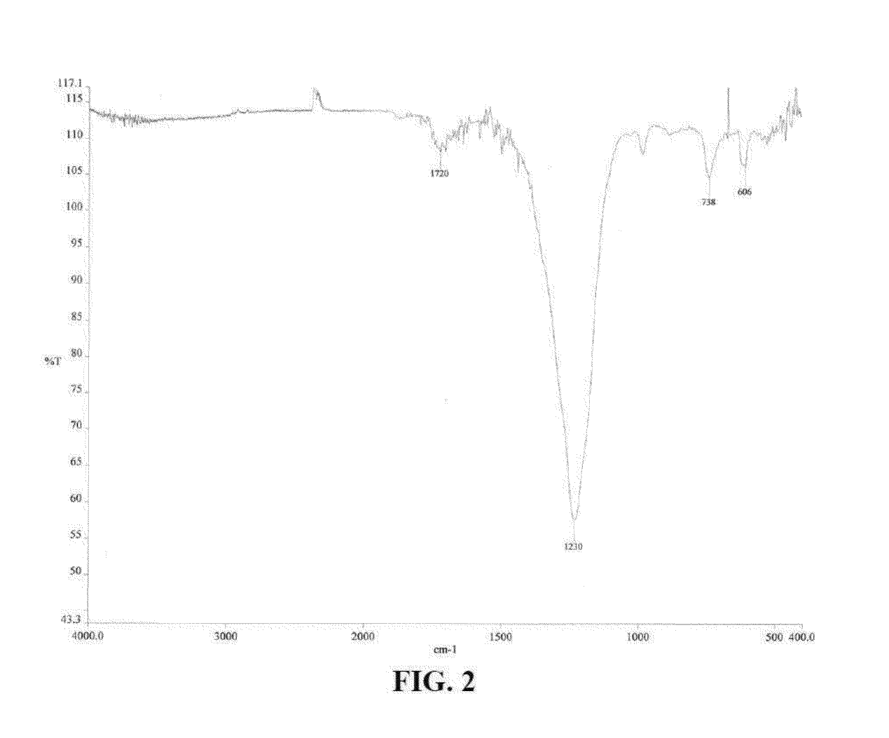

Silicon wafers have been processed under identical conditions in order to analyze the plasma chemistry. The FTIR spectrum collected from the above process closely matches that obtained from the pulsed process (FIG. 2). Under the conditions above, films are deposited at an average rate of 5 nm/min and yield water contact angles of 105-110°.

### Example 2

### Plasma Coating of Down Feathers Using Hexamethyldisiloxane (HMDSO) as the Monomer

Down feathers (7.5 g) are preloaded into a plastic mesh tube and placed in a 100° F. oven overnight prior to plasma processing in order to remove adsorbed water. The tube is then loaded into a plasma chamber and vacuum is drawn down to a base pressure of 0-3 mTorr. Hexamethyldisiloxane (HMDSO) is introduced into the chamber at a flow rate of 50 standard cubic centimeters per minute (sccm). A throttle valve wired to a pressure controller and transducer is utilized to achieve a constant pressure between 1-1500 mTorr. Radio frequency (RF) energy at 13.56 MHz is discharged between two parallel plate electrodes residing on opposite sides of the plasma chamber. A pulsing method allows for a lower overall average energy than typical continuous wave processes. During processing, the plastic mesh tube is rotated to ensure uniform coating. The process time is 50 minutes after which point the feathers are removed from the chamber and conditioned overnight at 70-75° F. and 60-65% relative humidity prior to vortex testing.

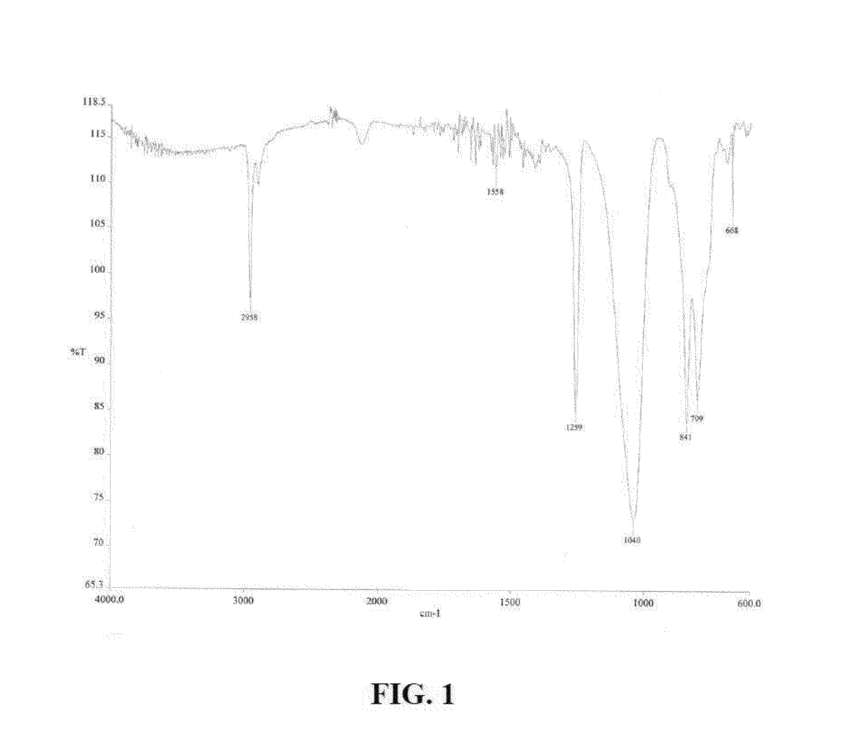

Silicon wafers have been processed under identical conditions in order to analyze the plasma chemistry. This technique allows us to obtain an FTIR spectrum of the deposited film, as well as measure water contact angle and film deposition rate. An FTIR spectrum for a typical HMDSO run is shown in FIG. 1. Under the conditions above, films are deposited at an average rate of 7 nm/min and yield water contact angles of 100-105°.

### Example 3

### Plasma Coating of Down Feathers Using Perfluorohexane (C6F14) AS THE MONOMER

Down feathers (7.5 g) are preloaded into a plastic mesh tube and placed in a 100° F. oven overnight prior to plasma processing in order to remove adsorbed water. The tube is then loaded into a plasma chamber and vacuum is drawn down to a base pressure of 0-3 mTorr. Perfluorohexane (C6F14) is introduced into the chamber at a flow rate of 150 sccm. A throttle valve wired to a pressure controller and transducer is utilized to achieve a constant pressure between 1-1500 mTorr. Radio frequency (RF) energy at 13.56 MHz is discharged between two parallel plate electrodes residing on opposite sides of the plasma chamber. A pulsing method allows for a lower overall average energy than typical continuous wave processes. During processing, the plastic mesh tube is rotated to ensure uniform coating. The process time is 40 minutes after which point the feathers are removed from the chamber and conditioned overnight at 70-75° F. and 60-65% relative humidity prior to vortex testing.

Silicon wafers have been processed under identical conditions in order to analyze the plasma chemistry. An FTIR spectrum for a typical C6F14 run is shown in FIG. 2. Under the conditions above, films are deposited at an average rate of 8 nm/min and yield water contact angles of 100-110°.

### Example 4

### Plasma Coating of Down Feathers Using Hexafluoropropene Trimer (C9F18) as the Monomer

Down feathers (7.5 g) are preloaded into a plastic mesh tube and placed in a 100° F. oven overnight prior to plasma processing in order to remove adsorbed water. The tube is then loaded into a plasma chamber and vacuum is drawn down to a base pressure of 0-3 mTorr. Hexafluoropropene trimer (C9F18) is introduced into the chamber at a flow rate of 150 sccm. A throttle valve wired to a pressure controller and transducer is utilized to achieve a constant pressure between 1-1500 mTorr. Radio frequency (RF) energy at 13.56 MHz is discharged between two parallel plate electrodes residing on opposite sides of the plasma chamber. A pulsing method allows for a lower overall average energy than typical continuous wave processes. During processing, the plastic mesh tube is rotated to ensure uniform coating. The process time is 50 minutes after which point the feathers are removed from the chamber and conditioned overnight at 70-75° F. and 60-65% relative humidity prior to vortex testing.

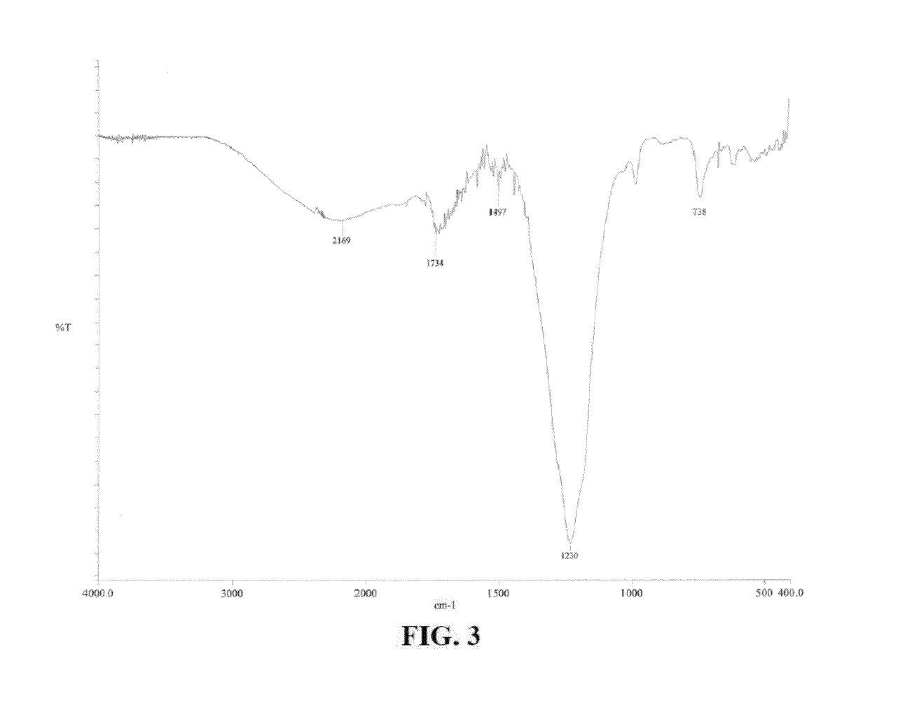

Silicon wafers have been processed under identical conditions in order to analyze the plasma chemistry. An FTIR spectrum for a typical C9F18 run is shown in FIG. 3. Under the conditions above, films are deposited at an average rate of 12 nm/min and yield water contact angles of 100-110°.

### Example 5

### Hydrophobicity as Measured by the Vortex Test

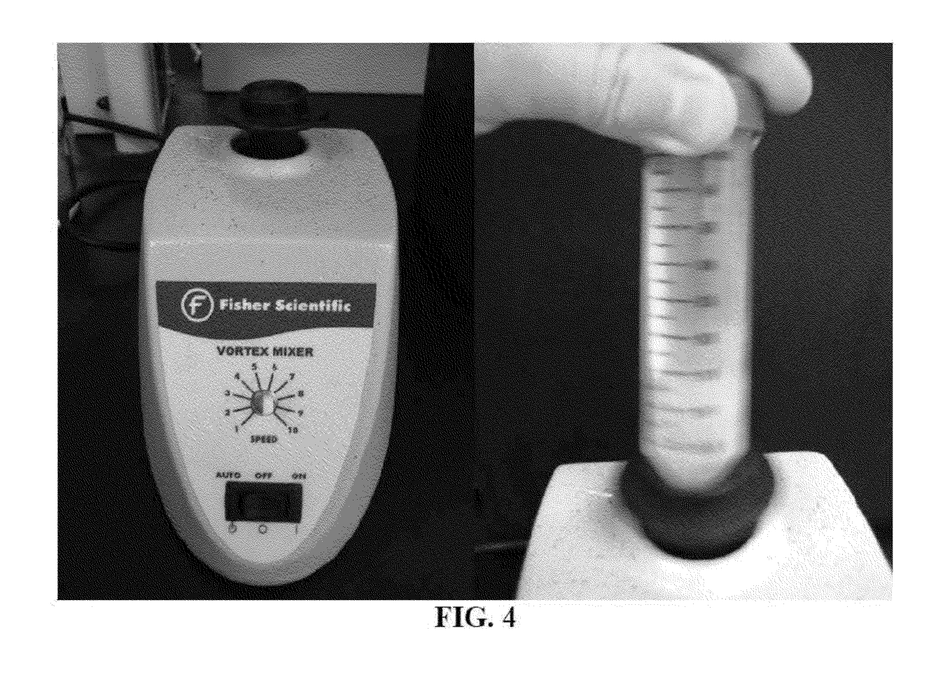

In order to assess the hydrophobicity and loft retention of plasma treated down feathers at the lab scale, a method for vortex testing was developed. The method involves a Fisher Scientific Vortex Mixer (FIG. 4) set to a speed of 8.5. By filling graduated centrifuge tubes with equivalent amounts of water, and vortexing each tube for equal amounts of time, we can be confident that we are imparting the same amount of agitation to each sample.

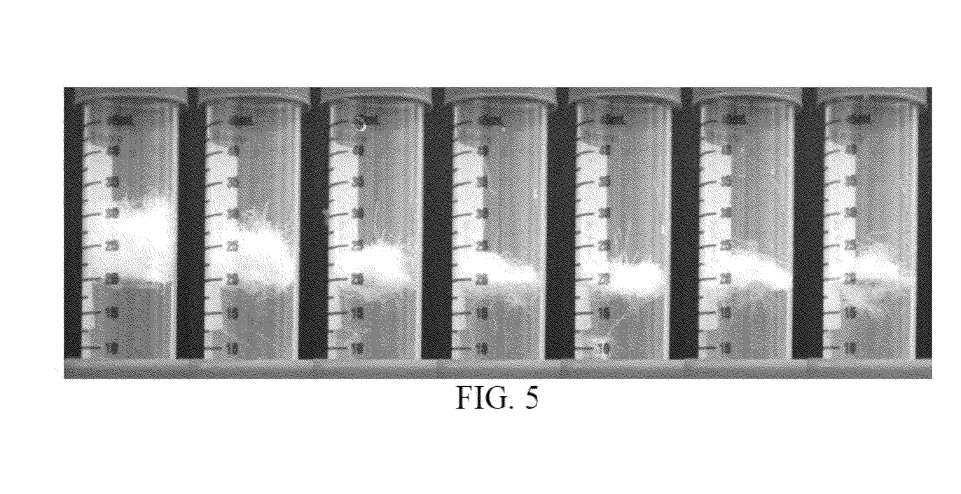

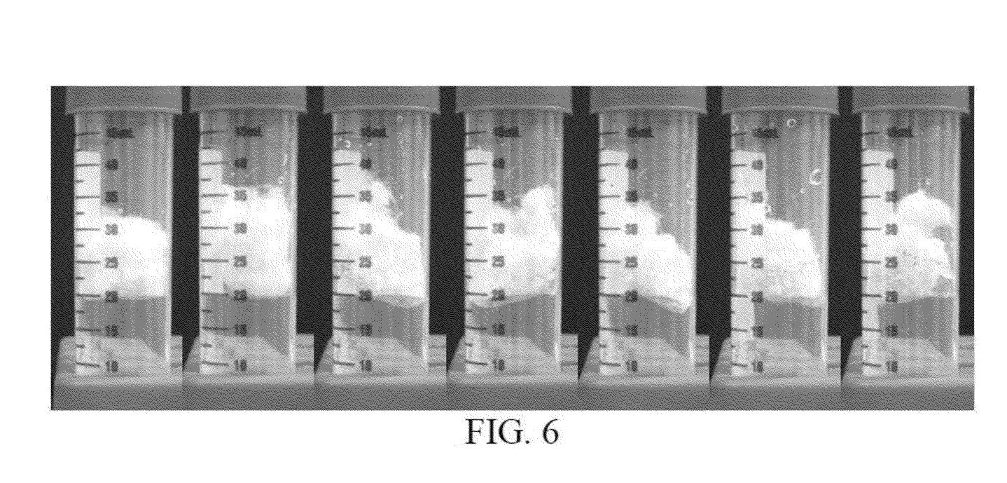

In a standard experiment, a centrifuge tube is filled with 20 mL of de-ionized water. A group of 10-15 treated feathers are added and the tube is sealed with a cap. Samples are vortexed for six 15-second increments, with digital images captured between each session. With the use of a tripod, we are able to ensure that image quality, angle, and magnification are identical from one picture to the next. FIG. 5 shows a series of images captured for 10-15 untreated feathers subjected to this test. In FIG. 6, test images from an equivalent amount of siloxane coated feathers are shown for comparison.

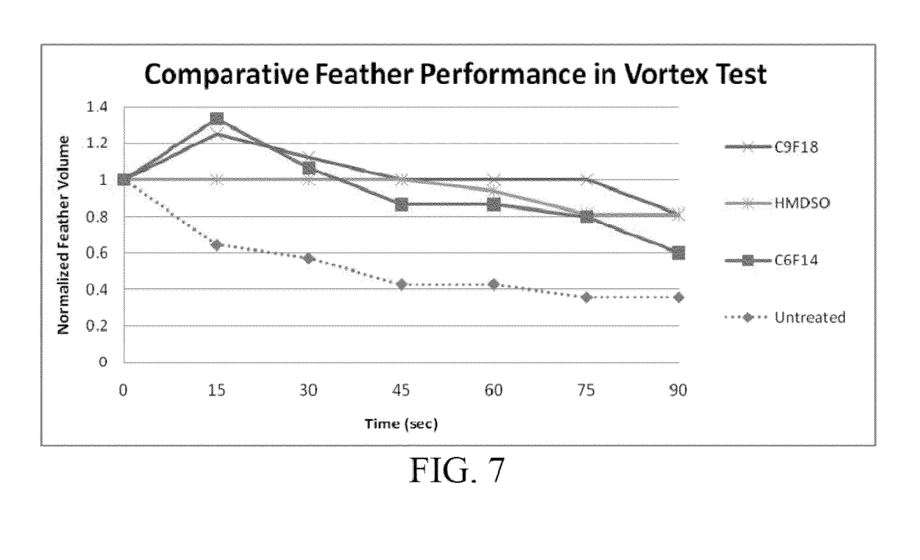

Utilizing the graduated markings on the sides of the vortex tube, feather volume can be loosely estimated. By charting the apparent volume vs. vortex time, a direct comparison can be made between the chemistries. Such a graph comparing the HMDSO, C6F14, and C9F18 treated feathers is shown in FIG. 7. All three types of feathers perform extremely well in comparison to the untreated feathers.

### Example 6

### Fill Power Comparison

The ability of treated down to fill more space, and therefore to provide a higher “fill power” is clearly demonstrated. Fill power is defined as the volume of space that one ounce of down insulation will fill when conditioned and prepared under exacting lab conditions.

Four samples from the same down lot were prepared, three were treated by plasma deposition of three different water repellent chemistries under investigation, one sample was left untreated as a control for comparison. Tests were conducted at IDFL, a world recognized independent down testing facility in Salt Lake City, Utah, using the industry standard fill power test method established by the International Down and Feather Bureau (see attached method).

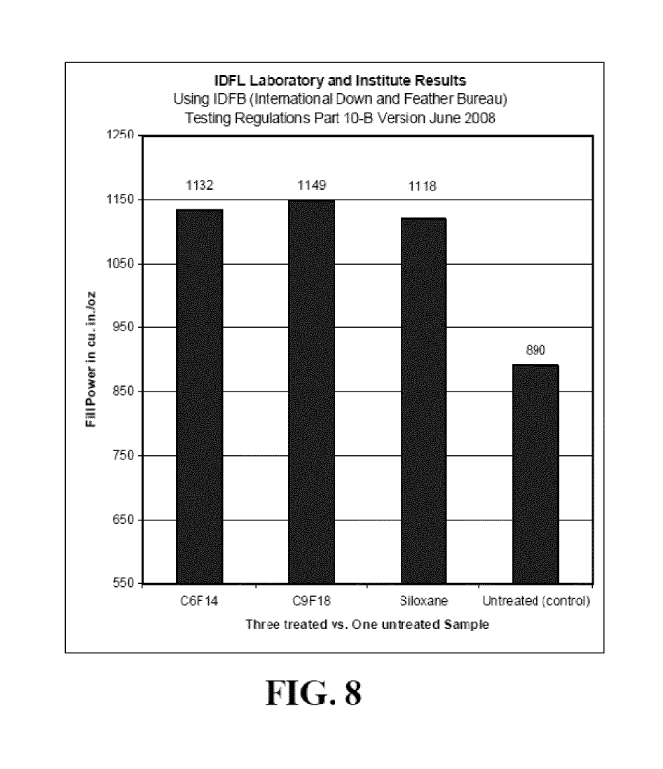

Results were startlingly conclusive. (See FIG. 8) The three treated samples had 20-23% higher fill power than the untreated sample. In all three cases the treated down will therefore fill more space in a garment, sleeping bag or comforter, meaning less down is required to achieve the same loft in any down filled article.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A plasma deposition process comprising the steps of:
providing one or more feathers;
providing a coating material;
providing a plasma discharge reactor; and
deposing a film of the coating material on the surface of the one or more feathers by plasma deposition.

2. The process of claim 1 wherein the step of deposing the film by plasma deposition is performed under sub-atmospheric pressure.

3. The process of claim 2 wherein the subatmospheric pressure is less than 20 Torr.

4. The process of claim 2 wherein the subatmospheric pressure is less than 10 Torr.

5. The process of claim 2 wherein the subatmospheric pressure is less than 5 Ton.

6. The process of claim 2 wherein the subatmospheric pressure is less than 1 Ton.

7. The process of claim 2 wherein the subatmospheric pressure is less than 5 milliTorr.

8. The process of claim 1, wherein the one or more feathers comprise down feathers.

9. The process of claim 1 wherein the step of deposing the film is performed under continuous-wave plasma discharge.

10. The process of claim 1 wherein the step of deposing the film is performed under pulsed plasma discharge.

11. The process of claim 1, wherein the step of deposing the film further comprises the step of varying the duty cycle.

12. The process of claim 1, wherein the step of deposing the film further comprises the step of varying the power input.

13. The process of claim 1, wherein the step of deposing the film further comprises the step of varying the peak power.

14. The process of claim 1, wherein the step of deposing the film further comprises the step of varying the flow rate of the monomer.

15. The process of claim 1, wherein the step of deposing the film further comprises the step of varying the pressure of the reactor.

16. The process of claim 1, wherein the step of deposing the film further comprises the step of varying the deposition time period.

17. The process of claim 1, wherein the step of providing the one or more feathers further comprises the step of varying the quantity of feathers introduced into the reactor.

18. The process of claim 1 wherein the step of deposing the film is performed under pulsed plasma discharge and continuous-wave plasma discharge.

19. The process of claim 1, wherein the one or more coating materials increase moisture resistance of the one or more feathers.

20. The process of claim 1, wherein the one or more coating materials increase hydrophobicity of the one or more feathers.

21. The process of claim 1, wherein the one or more coating materials increase loft of the one or more feathers.

22. The process of claim 1, wherein the coating material comprises a perfluorocarbon compound.

23. The process of claim 1, wherein the coating material comprises a siloxane compound.

24. The process of claim 1, wherein the coating material comprises one or more of hexafluoro-propylene oxide (C3F6O), perfluoro-2-butyltetrahydrofuran (PF2BTHF, C8F16O), perfluorohexane (C6F14), hexafluoropropene trimer (C9F18), perfluoropropylene (C3F6), and hexamethyldisiloxane (HMDSO).

25. The feather treated by the process of claim 1.

26. The feather of claim 25 wherein the feather is a down feather.

27. A structure comprising:
a feather; and
a coating material deposited onto the surface of the feather wherein the coating material is between 7 and 1000 nm thick.

28. The structure of claim 27, wherein the feather is a down feather.

29. The structure of claim 27, wherein the coating material comprises a perfluorocarbon compound.

30. The structure of claim 27, wherein the coating material comprises a siloxane compound.

31. The structure of claim 27, wherein the coating material improves the fill power of the feather by at least ten percent (10%).

32. A feather coated with a siloxane compound wherein the coating is between 7 and 1000 nm thick.

33. A feather coated with a compound, wherein the compound is deposited by plasma deposition.

34. The feather of claim 33, wherein the plasma deposition is performed under continuous-wave plasma discharge.

35. The feather of claim 33, wherein the plasma deposition is performed under pulsed plasma discharge.

36. A feather treated by gas phase pulsed plasma polymerization.

37. An article comprising:
a textile portion; and
an insulating portion, wherein the insulating portion comprises one or more feathers having a surface treated by deposing a film of a coating material on the surface of the one or more feathers by plasma deposition.
